(19) United States
(12) Patent Application Publication
(10) Pub. No.: US 2009/0148806 A1
(43) Pub. Date: Jun. 11, 2009

(54) Control Device for the Drive of a Dental Handpiece

(75) Inventors: Johannes Sauter, Mittelbuch (DE); Richard Buerk, Alberweiler (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Kaltenbach & Voigt GmbH, Biberach (DE)

(21) Appl. No.: 11/926,923

(22) Filed: Oct. 29, 2007

(30) Foreign Application Priority Data
Oct. 31, 2006 (DE) 10 2006 051506.4

(51) Int. Cl. A61C 3/00

(52) U.S. Cl. 433/28

(57) ABSTRACT

A control device for the drive of a dental handpiece has visual or acoustic indicating means for generating a warning signal if the torque exerted on a tooth to be worked or the material removal power exerted on a tooth to be worked exceeds a predetermined limit value.

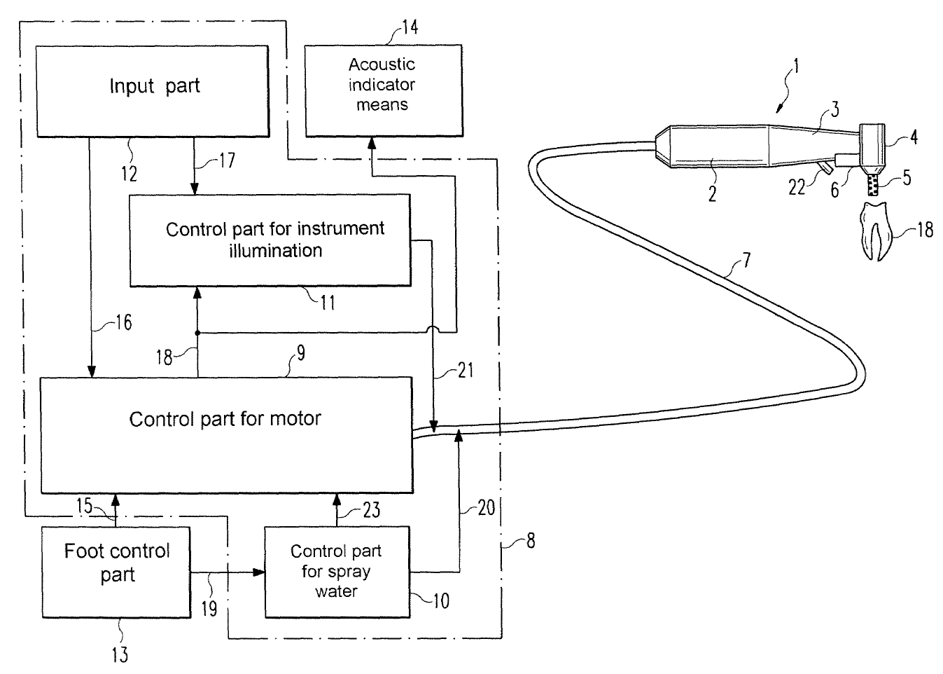

### BACKGROUND OF THE INVENTION

1. Field of the Invention

The invention concerns a control device for the drive of a dental handpiece.

2. Related Technology

Control devices for the drive of dental handpieces are known in many forms. If the drive for the dental handpiece is an electric motor, then as a rule the device controls the current for the electric motor and with that its power. If the drive for the dental handpiece is an air turbine, then the device controls the quantity of the air supplied to the turbine per unit time and thus also the power. When the tool of the dental handpiece is, in the rotating condition, placed on a tooth, then the handpiece must deliver a power which is increased with respect to the no-load power, or increased torque. Thus, the control devices for dental handpieces are usually configured so that, even at increased power or increased torque the speed of rotation is kept as constant as possible, or at least does not substantially decrease. In the event that the drive for the dental handpiece is an electric motor this can be brought about by a speed control.

One disadvantage with known control devices is that the dentist does not have feedback concerning the power delivered to the tooth or the torque required for operation under load. As a result, overheating and resulting damage to the tooth may occur.

### SUMMARY OF THE INVENTION

The invention therefore provides a control device to avoid the disadvantage described above.

Accordingly, the invention provides a control device for a dental handpiece, and a dental handpiece incorporating such a device, comprising an indicator or indicating means, such as a visual or acoustic indicator or indicating means for generating a warning signal, which functions if the torque exerted on the tooth to be worked or the material removal power exerted on the tooth to be worked exceeds a predetermined limit value.

The visual or acoustic warning signal, which is issued in the event that the limit value is exceeded, induces the dentist to reduce the torque or the material removal power. The dentist can do this in that he reduces the pressing force exerted the handpiece.

In accordance with a preferred configuration of the invention the visual indicating means functions in that a light of the instrument illumination pulsates or changes its color when the limit value is exceeded.

In the case of acoustic indicating means, a buzzer or loudspeaker, for example, issues an acoustic warning signal when the limit value is exceeded.

In another embodiment, the limit value is a function of the spray water quantity issued by the dental handpiece. Since the danger of overheating is reduced by supplying spray water to the drilling site, the limit value can correspondingly be set higher. If it is assumed that the overheating of a tooth is merely delayed by the supply of spray water, then the control device can also be so set that on preselection of a small spray water quantity the warning is effected sooner and in the case of a high spray water quantity the warning is effected later.

### BRIEF DESCRIPTION OF THE DRAWINGS

An embodiment of the invention is described below with reference to the accompanying drawing, which is a schematic representation with a dental handpiece with a control device according to the invention.

### DETAILED DESCRIPTION

The drawing shows a dental handpiece 1 the drive of which is an electric motor 2. A forward handpiece part 3, which is disposed on the electric motor, carries a head 4 in which a tool 5 is mounted. In the vicinity of the head 4 there is located on the forward handpiece part 3 a light source 6 forming the instrument illumination for the illumination of the drilling site on the tooth 18. Further there is located at the forward handpiece part 3 a nozzle 22 through which spray water is sprayed onto the site of working on the tooth, to cool the site.

The dental handpiece 1 is connected to a control device by a supply hose 7, through which the media which the dental handpiece 1 needs for operation are delivered to the dental handpiece 1. In the case of a dental handpiece operated with an electric motor these media are the motor current, the current required for the instrument illumination, spray water, and air. If a dental handpiece with a turbine drive is involved, at least motor current and possibly also current for the instrument illumination are omitted. In this case the delivery of air to operate the turbine is necessary.

The control device 8 contains a control part 9 for the motor, a control part 10 for the spray water, a control part 11 for the instrument illumination, and an input part 12. There are further provided a foot control part 13 and acoustic indicator means 14, which may be or are arranged outside the control device 8.

Limit values for the torque or the material removal power can be entered into the input part 12, which values are passed on to the control part 9 for the motor. Further, there can be entered into the input part 12 determined control values for the instrument illumination which are passed on to the control part for the instrument illumination. Thus it is possible for example, by means of corresponding inputs into the input part 12, to determine whether, in the case of a limit value for the torque or the material removal power being exceeded, the instrument illumination issues a pulsating light or changes color. In the case of pulsating light the pulsation frequency can be input. The current for the light source 6 for instrument illumination is supplied to the supply hose 7 from the control part 11 for instrument illumination via a line 16.

With a foot control part 13 variable control data regarding a desired motor speed can be produced, which data are delivered to the control part 9 for the motor. By actuation of the foot control part 13 with the foot the dentist can therefore change the speed of rotation or the material removal power of the dental handpiece between zero and the limit value.

With the foot control part 13 there can further be produced control signals for the spray water which are delivered to the control part 10 for the spray water. As a rule, the spray water can be turned on or off in this way by actuation of the foot control part 13. The spray water is supplied to the supply hose from the control part 10 for the spray water via a line 17.

The control part 10 for the spray water further reports to the control part 9 for the motor whether and in what quantity spray water is delivered, or not, to the site to be worked on the tooth.

The control part 9 for the motor usually includes a regulator for the motor current, in order not to allow the speed of rotation to fall excessively even under load. This means that the motor current rises upon loading, in order to be able to produce the increased torque or the then increased material removal power required as a result of the load. If, however, the limit value for the torque or the material removal power entered into the input part 12 is exceeded, the control part 9 for the motor produces corresponding warning signals which are delivered to the control part 11 for the instrument illumination and/or the acoustic indicator means 14. In this event for example the control part 11 for the instrument illumination issues a pulsating illumination current and/or the acoustic indicating means 14 formed by a buzzer or a loudspeaker issue an acoustic warning signal. Through this the dentist recognizes that the site of working on the tooth 18 can overheat and he can reduce the pressure on the dental handpiece, in order therewith to also reduce the torque or the material removal power such that it falls below the limit value.

Since the supply of spray water delays overheating of the site on the tooth to be worked or, with the torque or the material removal power selected in each case, completely prevents overheating, there is taken into account for the generation of the warning signal the information which is supplied to the control part 9 for the motor from the control part 10 for the spray water. This then has the consequence that the warning signal is produced either later or only at a higher torque or a higher material removal power. The first alternative means that the warning signal is delayed temporally; the second alternative means that the limit value is increased. In both cases the limit value is thus a function of the spray water quantity issued by the dental handpiece 1.

In the described embodiment the control device 8 has, for better understanding, been described in the form of circuitry blocks as a hardware solution. All or a part of the blocks can be combined to a single block and the functions realized by a software solution.

1. Control device for the drive of a dental handpiece, comprising indicating means for generating a visual or acoustic warning signal if torque exerted on a tooth to be worked or material removal power exerted on a tooth to be worked exceeds a predetermined limit value.

2. Control device of claim 1, wherein the indicating means comprises visual indicating means.

3. Control device of claim 2, wherein instrument illumination light pulsates or changes color when the limit value is exceeded.

4. Control device according to claim 1, wherein the indicating means comprises acoustic indicating means which issues an acoustic warning signal when the limit value is exceeded.

5. Control device of claim 4, wherein the acoustic indicating means is a buzzer or loudspeaker.

6. Control device according to claim 1, wherein the limit value is a function of spray water issued by the dental handpiece.

7. Control device for the drive of a dental handpiece, comprising an indicator for generating a visual or acoustic warning signal if torque exerted on a tooth to be worked or material removal power exerted on a tooth to be worked exceeds a predetermined limit value.

8. Control device of claim 7, wherein the indicator comprises a visual indicator.

9. Control device of claim 8, wherein instrument illumination light pulsates or changes color when the limit value is exceeded.

10. Control device according to claim 7, wherein the indicator comprises an acoustic indicator which issues an acoustic warning signal when the limit value is exceeded.

11. Control device of claim 10, wherein the acoustic indicator is a buzzer or loudspeaker.

12. Control device according to claim 7, wherein the limit value is a function of spray water issued by the dental handpiece.
